(19) United States
(12) Patent Application Publication
(10) Pub. No.: US 2023/0312895 A1
(43) Pub. Date: Oct. 5, 2023

(54) MULTIMODAL HDPE FOR BLOW MOLDING APPLICATIONS

(71) Applicant: Braskem S.A., Camaaçari (BR)

(72) Inventors: Camila Pilatti Mainka, São Paulo (BR); Leonardo Souza Bento, São Paulo (BR); Arthur Vieira Dalmagro, São Paulo (BR); Matheus Borlino Lotumolo, São Paulo (BR); Fernanda Franco Tonelotti, São Paulo (BR); Gustavo Todescato Dassi, São Paulo (BR)

(73) Assignee: Braskem S.A., Camaaçari (BR)

(21) Appl. No.: 18/192,517

(22) Filed: Mar. 29, 2023

Related U.S. Application Data
(60) Provisional application No. 63/324,930, filed on Mar. 29, 2022.

(51) Int. Cl. C08L 23/08; B29C 49/00

(52) U.S. Cl. CPC C08L 23/0815; B29C 49/0005; C08L 2207/062; C08L 2207/064; C08L 2205/025; C08L 2314/02; B29C 49/06

(57) ABSTRACT

A polyethylene composition comprising may include a multimodal high-density polyethylene, comprising at least a lower molecular weight fraction and a higher molecular weight fraction, and a low density polyethylene, wherein the low-density polyethylene is present in an amount of greater than 1 to 20% by percent weight of the total composition. Methods for increasing die swell in blow molding processes may include polymerizing ethylene and optionally one or more alpha-olefin comonomers to obtain a multimodal HDPE comprising at least a lower molecular weight fraction and a higher molecular weight fraction, and blending a low-density polyethylene with the multimodal HDPE.

### BACKGROUND

Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. However, physical and chemical properties of polyolefin compositions may exhibit varied responses depending on a number of factors such as molecular weight, distribution of molecular weights, content and distribution of comonomer (or comonomers), method of processing, and the like.

Methods of manufacturing may utilize polyolefin's limited inter-and intra-molecular interactions, capitalizing on the high degree of freedom in the polymer to form different microstructures, and to modify the polymer to provide varied uses in a number of technical markets. However, polyolefin materials may have a number of limitations, which can restrict application such as susceptibility to deformation and degradation in the presence of some chemical agents, and low barrier properties to various gases and a number of volatile organic compounds (VOC). Property limitations may hinder the use of polyolefin materials in the production of articles requiring low permeability to gases and solvents, such as packaging for food products, chemicals, agrochemicals, fuel tanks, water and gas pipes, and geomembranes, for example.

While polyolefins are utilized in industrial applications because of favorable characteristics such as high processability, low production cost, flexibility, low density, and ease of recycling, polyolefin compositions may have physical limitations, such as susceptibility to environmental stress cracking (ESC). In particular, environmental stress cracking is a phenomenon where a molded article develops brittle cracks with time due to a synergistic action of chemicals and stress when chemicals such as chemical substances attach to or contact a portion loaded with a tensile stress (a stressed portion).

Conventionally, methods of altering the chemical nature of the polymer composition may include modifying the polymer synthesis technique, including catalyst, the inclusion of one or more comonomers, or through blending. However, modifying the polyolefin may also result in undesirable side effects. By way of illustration, increasing the molecular weight of a polyolefin may produce changes in the ESC, but can also increase viscosity, which may limit the processability and moldability of the polymer composition.

Polymer modification by blending may vary the chemical nature of the composition, resulting in changes to the overall physical properties of the material. Material changes introduced by polymer blending may be unpredictable, however, and, depending on the nature of the polymers and additives incorporated, the resulting changes may be uneven and some material attributes may be enhanced while others exhibit notable deficits.

Accordingly, there exists a continuing need for developments blow molded products to have increases in environmental stress cracking resistance while balancing other properties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to polyethylene compositions comprising a multimodal high-density polyethylene, comprising at least a lower molecular weight fraction and a higher molecular weight fraction, and a low density polyethylene, wherein the low-density polyethylene is present in an amount of greater than 1 to 20% by percent weight of the total composition.

In another aspect, embodiments disclosed herein relate to methods for increasing die swell in a blow molding process, the process including polymerizing ethylene and optionally one or more alpha-olefin comonomers to obtain a multimodal HDPE comprising at least a lower molecular weight fraction and a higher molecular weight fraction, and blending a low-density polyethylene with the multimodal HDPE.

In another aspect, embodiments disclosed herein relate to a blow-molded article comprising the polyethylene composition comprising a multimodal high-density polyethylene, comprising at least a lower molecular weight fraction and a higher molecular weight fraction, and a low density polyethylene.

Other aspects and advantages of the claimed subject matter will be apparent from the following description and the appended claims.

### BRIEF DESCRIPTION OF DRAWINGS

FIG. 1 shows the die swell of multimodal HDPE neat and blended with an LDPE at 5 wt %, 10 wt %, and 15 wt % according to Examples 1-4.

FIG. 2 shows the die swell of a multimodal HDPE neat and blended with an LDPE at 5 wt %, 10 wt %, and 15 wt % according to Example 5.

FIG. 3 shows the die swell of multimodal HDPE neat and blended with an LDPE at 5 wt % and 10 wt % according to Examples 6-8.

FIG. 4 shows the die swell of comparative examples of bimodal and monomodal HDPE neat and blended with an LDPE at 0.5 wt %, 1 wt %, and 5 wt % according to Examples 9-10.

FIG. 5 shows the die swell vs. complex viscosity ratio for Examples 1-5 and 9-10.

FIG. 6 shows the die swell vs. complex viscosity ratio for Examples 6-8.

FIG. 7 shows the die swell vs. tansδ for Examples 1-5 and 9-10.

FIG. 8 shows the die swell vs. tansδ for Examples 6-8.

### DETAILED DESCRIPTION

Embodiments disclosed herein relate to polyethylene polymer compositions for blow molding applications that include a multimodal high-density polyethylene (HDPE), such as those multimodal HDPEs produced by Ziegler-Natta (ZN) catalysts. Such multimodal HDPE produced by ZN catalysts may have good ESCR properties, and small amounts of low-density polyethylene (LDPE) may be added to increase the die swell of the ZN blow molding grades. Advantageously, such LDPE, due to its higher degree of long chain branches, may provide an increase in the material elasticity and a corresponding increase in the die swell.

In one or more embodiments, a composition for blow molding processes is provided, which may include a multimodal high-density polyethylene and a low-density polyethylene. The multimodal high-density polyethylene may comprise at least a lower molecular weight fraction, and a higher molecular weight fraction. The low-density polyethylene may be present in an amount ranging from greater than 1 to 20% by weight of the total composition.

In one or more embodiments, the multimodal high-density polyethylene may be present in an amount, with respect to the total weight of the composition, ranging from a lower limit of any of 80 wt %, 83 wt %, 85 wt %, to an upper limit of any of 90 wt %, 95 wt %, 97 wt %, 98 wt % or 99 wt %, where any lower limit can be used in combination with any upper limit.

As known by those skilled in the art, multimodal polyethylene polymers may comprise at least two polyethylene fractions, which are produced under different polymerization conditions and/or using two or more different catalysts, resulting in different molecular weights for each fraction, therefore called “multimodal”. The prefix “multi” refers to the number of different polymer fractions present in the polymer. A polymer consisting of only two fractions is called “bimodal”.

In any multimodal polyethylene there is by definition a lower molecular weight component (LMW) and a higher molecular weight component (HMW). The LMW component has a lower molecular weight than the higher molecular weight component.

The multimodal high-density polyethylene may be polymerized by any method suitable to obtain the desired properties. In one or more embodiments, the multimodal high-density polyethylene is polymerized in the presence of a Ziegler-Natta catalyst in two or more serially connected polymerization reactors. Any suitable polymerization process known in the art may be used to produce the multimodal HDPE such as polymerization in gas-phase, solution, slurry, and combinations thereof. In particular embodiments, the multimodal HDPE may be produced in two or more serially connected slurry polymerization reactors, such as loop or tank reactors. In particular embodiments where the multimodal HPDE is a bimodal HDPE, the bimodal HDPE may be produced in two serially connected reactors, wherein the lower molecular weight fraction is produced in the first reactor and the higher molecular weight fraction is produced in the second rector or vice-versa.

The multimodal high-density polyethylene may include ethylene homopolymers or copolymers of ethylene and one or more C3-C20 alpha-olefins. In one or more embodiments, alpha-olefins may be selected from the group consisting of propylene, 1-butene, 1-hexene, 1-octene, and combinations thereof. In particular embodiments, the multimodal high-density polyethylene is an ethylene/1-butene copolymer. According to the present disclosure, each fraction of the multimodal HDPE may be an ethylene homopolymer or a copolymer of ethylene and one or more alpha-olefin comonomer. In particular embodiments, the lower molecular weight fraction is an ethylene homopolymer and the higher molecular weight fraction is an ethylene/alpha-olefin copolymer. In other embodiments, the lower molecular fraction and the higher molecular weight fractions are ethylene/alpha-olefin copolymers.

In some embodiments, the high-density polyethylene may include polymers generated from petroleum based monomers and/or biobased monomers (such as ethylene obtained from sugarcane derived ethanol). Commercial examples of biobased polyolefins are the “I'm Green”™ line of bio-polyethylenes from Braskem S.A.

In one or more embodiments, the multimodal high-density polyethylene may have a density of 0.940 to 0.965 g/cm³, measured according to ASTM D792. The lower molecular weight fraction may have a density of 0.950 to 0.970 g/cm³. The higher molecular weight fraction may have a density of 0.920 to 0.955 g/cm³.

In one or more embodiments, the multimodal high-density polyethylene may have a weight average molecular weight (Mw) ranging from a lower limit of any of 100 kg/mol, 130 kg/mol, 150 kg/mol, to an upper limit of any of 200 kg/mol, 250 kg/mol, or 300 kg/mol, where any lower limit can be used in combination with any upper limit.

In one or more embodiments, the multimodal high-density polyethylene may have a polydispersity index (Mw/Mn, where Mn is the number average molecular weight) of 8 to 30. For example, the multimodal high-density polyethylene may have a polydispersity index ranging from a lower limit of any of 8, 13, 18, to an upper limit of any of 20, 25, or 30, where any lower limit can be used in combination with any upper limit.

Within the multimodal high-density polyethylene, the lower molecular weight fraction may have a Mw ranging from a lower limit of any of 30 kg/mol, 50 kg/mol, 70 kg/mol, to an upper limit of any of 80 kg/mol, 90 kg/mol, or 100 kg/mol where any lower limit can be used in combination with any upper limit, and a polydispersity index ranging from a lower limit of any of 3, 5, 7, to an upper limit of any of 9, 11, or 13, where any lower limit can be used in combination with any upper limit.

The GPC experiments may be carried out by gel permeation chromatography coupled with triple detection, with an infrared detector IR5 and a four-bridge capillary viscometer (PolymerChar) and an eight-angle light scattering detector (Wyatt). A set of 4 mixed bed, 13 μm columns (Agilent) may be used at a temperature of 150° C. The experiments may use a concentration of 1 mg/mL, a flow rate of 1 mL/min, a dissolution temperature and time of 160° C. and 90 minutes, respectively, an injection volume of 200 μL, and a solvent of 1,2,4-trichlorobenzene stabilized with 300 ppm of BHT.

In one or more embodiments, the lower molecular weight fraction may be present in an amount, with respect to the multimodal HDPE, ranging from a lower limit of any of 40 wt %, 45 wt %, 50 wt %, to an upper limit of any of 50 wt %, 60 wt %, or 70 wt %, where any lower limit can be used in combination with any upper limit.

In one or more embodiments, the higher molecular weight fraction may be present in an amount, with respect to the multimodal HDPE, ranging from a lower limit of any of 30 wt %, 40 wt %, 50 wt %, to an upper limit of any of 50 wt %, 55 wt %, or 60 wt %, where any lower limit can be used in combination with any upper limit.

In one or more embodiments, the multimodal HDPE may have a melt index (I₂) ranging from a lower limit selected from one of 0.05, 0.1, and 0.15 g/10 min to an upper limit selected from one of 0.40, 0.45, and 0.5 g/10 min according to ASTM D1238 at 190° C./2.16 kg, where any lower limit can be used in combination with any upper limit.

In one or more embodiments, the multimodal HDPE may have a melt index (I₂₁) ranging from a lower limit selected from one of 6, 8, and 10 g/10 min to a higher limit selected from one of 36, 38, and 40 g/10 min according to ASTM D1238 at 190° C./21.6 kg, where any lower limit can be used in combination with any upper limit.

In one or more embodiments, the lower molecular weight fraction may have a melt index (I₂) ranging from a lower limit selected from one of 10, 20, and 30 g/10 min to an upper limit selected from one of 40, 50, and 60 g/10 min according to ASTM D1238 at 190° C./2.16 kg, where any lower limit can be used in combination with any upper limit.

In one or more embodiments, the lower molecular weight fraction may have a melt index (I₅) ranging from a lower limit selected from one of 30, 40, and 50 g/10 min to a higher limit selected from one of 130, 140, and 150 g/10 min according to ASTM D1238 at 190° C./5.0 kg, where any lower limit can be used in combination with any upper limit.

In one or more embodiments, the lower molecular weight fraction may have a melt index (I₂₁) ranging from a lower limit selected from one of 80, 100, and 120 g/10 min to a higher limit selected from one of 330, 340, and 350 g/10 min according to ASTM D1238 at 190° C./21.6 kg, where any lower limit can be used in combination with any upper limit.

In one or more embodiments, the higher molecular weight fraction may have a melt index (I₂₁) ranging from a lower limit selected from one of 0.1, 0.5, and 1.0 g/10 min to a higher limit selected from one of 3, 5, and 7 g/10 min according to ASTM D1238 at 190° C./21.6 kg, where any lower limit can be used in combination with any upper limit.

In those cases when the HDPE is a bimodal polyethylene, the melt index (either I₂, I₅ or I₂₁) of both fractions may be estimated by the following expression:

Log I_{xHDPE}=W_{LMW fraction}×Log I_{x LMW fraction}+W_{HMW fraction}×Log I_{x HMW fraction}
wherein Log I_{xHDPE} is the Log Iₓ of the bimodal HDPE, W_{LMW fraction} is the weight fraction of the low molecular weight fraction, Log I_{x LMW fraction} is the Log Iₓ of the low molecular weight fraction, W_{HMW fraction} is the weight fraction of the high molecular weight fraction, Log I_{x HMW fraction} is the Log Iₓ of the high molecular weight fraction, and wherein the sum of both fractions LMW and HMW by weight (W_{LMW fraction}+W_{HMW fraction}) is 1. Iₓ can be I₂, I₅, or I₂₁.

In those cases when the HDPE is a bimodal polyethylene, the density of both fractions may be estimated by the following expression:

1/Density_{HDPE}=W_{LMW fraction}/Density_{LMW fraction}+W_{HMW fraction}/Density_{HMW fraction}
wherein Density_{HDPE} is the density of the bimodal HDPE, W_{LMW fraction} is the weight fraction of the low molecular weight fraction, Density_{LMW fraction} is the density of the low molecular weight fraction, W_{HMW fraction} is the weight fraction of the high molecular weight fraction, Density_{HMW fraction} is the density of the high molecular weight fraction, and wherein the sum of both fractions LMW and HMW by weight (W_{LMW fraction}+W_{HMW fraction}) is 1.

As mentioned above, the low-density polyethylene may be present in the polymer composition in an amount ranging from greater than 1 wt % to 20 wt %, with respect to the total weight of the composition. For example, the low-density polyethylene may be present at a lower limit of any of 1.1, 1.5, 2, 2.5, 3, 3.5, 4, 4.5, or 5 wt %, and an upper limit of any of 5, 8, 10, 12, 15, 18, or 20 wt %, where any lower limit can be used in combination with any upper limit.

Low-density polyethylenes (LDPE) are typically produced in high pressure, free radical polymerization processes, usually using a tubular reactor, or an autoclave reactor, or combinations of both.

In one or more embodiments, the low-density polyethylene may have a density measured according to ASTM D792 that is at most 0.935 g/cm³. For example, the polyethylene may have a density that is of an amount ranging from a lower limit of any of 0.910, 0.914, 0.916, 0.918, or 0.920 g/cm³ to an upper limit of any of 0.922, 0.924, 0.926, 0.930, or 0.935 g/cm³, where any lower limit can be used in combination with any upper limit.

In one or more embodiments, the low-density polyethylene may have an intrinsic viscosity measured according to ASTM D445 ranging from a lower limit of any of 1.0, 1.1, 1.2 dl/g, to an upper limit of any of 1.5, 1.75, or 2.0 dl/g, where any lower limit can be used in combination with any upper limit.

In one or more embodiments, the low-density polyethylene may have a melt index (I₂) ranging from a lower limit selected from one of 0.01, 0.05, 0.1, or 0.12 g/10 min to a, upper limit selected from one of 0.4, 0.5, 0.75, and 1.0 g/10 min according to ASTM D1238 at 190° C./2.16 kg, where any lower limit can be used in combination with any upper limit.

In one or more embodiments, the low-density polyethylene may have a Mw ranging from a lower limit of any of 10, 12, or 15 kg/mol, to an upper limit of any of 16, 18, or 20 kg/mol, where any lower limit can be used in combination with any upper limit. In one or more embodiments, the low-density polyethylene may have a polydispersity index ranging from a lower limit of any of 6, 7, or 8, to an upper limit of any of 9, 10, or 12, where any lower limit can be used in combination with any upper limit.

### Additives

In one or more embodiments, the polymer compositions of the present disclosure may contain a one or a number of other functional additives that modify various properties of the composition such as antioxidants, pigments, fillers, reinforcements, adhesion-promoting agents, biocides, slip agents, whitening agents, nucleating agents, anti-statics, anti-blocking agents, processing aids, flame-retardants, plasticizers, stabilizers, light stabilizers, and the like.

In one or more embodiments, the polyethylene composition has a die swell increase, relative to a die swell of the multimodal high-density polyethylene of between 10% and 70%. Such increase may depend on the amount of LDPE added to the multimodal HDPE, and the amount of die swell increase desired.

The die swell measurements may be carried out in an extruder (Kautex Ø: 50 mm and L/D: 20), screw rotation at 15 rpm, using a blow molding die having an outer diameter of 21.990 mm and an inner diameter of 19.979 mm. The temperature profile (barrel to die) for materials with I₂≤0.30 g/10 min may be 170/190/220/220/220° C. and for those with I₂>0.30 g/10 min 160/170/180/190/190° C. The Die Swell is expressed by the ratio between the weight of parison, per 15.7 cm, and the die section area, according to the equation 1:

$$Die swell [ \% ] = [ ( \frac{1.32 \times W}{L \times At} ) - 1 ] \times 100 \qquad ( Eq . 1 )$$

where 1.32 is the specific volume (cm³) of HDPE at 200° C. considering the polymer melt density of 0.75 g/cm³, W is the weight of the parison (g), L is the double scissors length (15.7 cm) and At is the die section area (0.663 cm²).

In one or more embodiments, the polyethylene composition for blow molding processes may have a complex viscosity ratio (ratio of complex viscosity at a frequency of 0.12 rad/s to the complex viscosity at a frequency of 121 rad/s) ranging from a lower limit of any of 10, 15, 20, or 25 to an upper limit of any of 35, 40, 45, or 50, where any lower limit can be used in combination with any upper limit. The complex viscosity ratio may be measured according to ASTM D440.

Compositions according to one or more embodiments may have an increase in the complex viscosity ratio (ratio of complex viscosity at a frequency of 0.12 rad/s to the complex viscosity at a frequency of 121 rad/s), relative to the complex viscosity ratio (ratio of complex viscosity at a frequency of 0.12 rad/s to the complex viscosity at a frequency of 121 rad/s) of the multimodal HDPE, ranging from a lower limit of any of 0.1%, 1%, 5%, 10%, to an upper limit of any of 12%, 15%, 20%, or 30% where any lower limit can be used in combination with any upper limit. The complex viscosity ratio may be measured according to ASTM D440.

Compositions according to one or more embodiments may have a relationship between the die swell (DS) and the complex viscosity ratio (ratio of complex viscosity at a frequency of 0.12 rad/s to the complex viscosity at a frequency of 121 rad/s) (CVR) which may be described by the equation: DS=(CVR*a1)−b1. According to embodiments, a1 may range from a lower limit of any of 5, 8, or 11, to an upper limit of any of 40, 50, 75, or 100, where any lower limit can be used in combination with any upper limit; and b1 may range from a lower limit of any of 100, 120, or 140, to an upper limit of any of 1440, 1700, or 2000, where any lower limit can be used in combination with any upper limit. The linear relationship is obtained by a linear regression of a CVR versus DS absolute values which are measured for at least three polyethylene compositions comprising the bimodal HDPE and 0 wt %, 5 wt %, and 10 wt % of the low-density polyethylene. The linear relationship may be characterized as having a R²>0.8.

Compositions according to one or more embodiments may have a relationship between the die swell (DS) and tan δ measured at a frequency of 0.12 rad/s (tan δ) which may be described by the equation: DS=-(tan δ*a2)+b2. According to embodiments, a2 may range from a lower limit of any of 200, 205, or 215, to an upper limit of any of 1700, 1850, or 2000, where any lower limit can be used in combination with any upper limit; and b2 may range from a lower limit of any of 300, 450, or 570, to an upper limit of 2000, 2500, 2900 or 3300. The linear relationship is obtained by a linear regression of a tan δ versus DS absolute values measured for at least three polyethylene compositions comprising the bimodal HDPE and 0 wt %, 5 wt %, and 10 wt % of the low-density polyethylene. The linear relationship may be characterized as having a R²>0.8.

In one or more embodiments, the polyethylene composition has a result of Bent strip test in 10% Igepal CO-630 in water (F₅₀) at 50° C. greater than 10 h, or greater than 30 h, or greater than 50 h, or greater than 100 h, or greater than 500 h, or greater than 1000 h as measured according to ASTM D1693, condition B.

In one or more embodiments, the polyethylene composition has a FNCT (Full-notch creep test) in MEG (monoethylene glycol) at 80° C. of greater than 50 min, or greater than 100 min, or greater than 150 min, or greater than 1,000 min, or greater than 3,000 min. In one or more embodiments, the polyethylene composition may have a FNCT ranging from 50 min to 50,000 min, as measured according to ISO 16670. The load for materials with I₂≤0.30 g/10 min may be 5 MPa and for those with I₂>0.30 g/10 min, 4 MPa.

In one or more embodiments, the polyethylene composition has a tan δ, measured at a frequency of 0.12 rad/s according to ASTM D440, ranging from a lower limit of any of 0.1, 0.2, 0.4, 0.5, 0.7, or 1.0 to an upper limit of any of 1.0, 1.5, 2.0, 2.5, 3.0, 3.5, or 4.0 where any lower limit can be used in combination with any upper limit.

Compositions according to one or more embodiments may have a reduction in tan δ measured at a frequency of 0.12 rad/s, relative to the tan δ measured at a frequency of 0.12 rad/s of the multimodal HDPE, ranging from a lower limit of any of 0.1%, 1%, 2%, 3%, to an upper limit of any of 5%, 10% ,15%, or 20%, where any lower limit can be used in combination with any upper limit. The tan δ may be measured according to ASTM D440.

Compositions according to one or more embodiments may have a melt index (I₂) ranging from a lower limit selected from one of 0.01, 0.05, and 0.1 g/10 min to an upper limit selected from one of 0.4, 0.45, and 0.50 g/10 min according to ASTM D1238 at 190° C./2.16 kg, where any lower limit can be used in combination with any upper limit.

Compositions according to one or more embodiments may have a melt index (I₂₁) ranging from a lower limit of any of 4, 6, and 8 g/10 min to an upper limit of any of 36, 38, or 40 g/10 min according to ASTM D1238 at 190° C./21.6 kg, where any lower limit can be used in combination with any upper limit.

Compositions according to one or more embodiments may have a melt index ratio (I₂₁/I₂) ranging from a lower limit selected from one of 20, 30, and 40, to an upper limit selected from one of 100, 110, and 120, where any lower limit can be used in combination with any upper limit.

Compositions according to one or more embodiments may have a 1% secant modulus (flexural modulus) ranging from a lower limit selected from one of 850, 900, and 1000 MPa, to an upper limit selected from one of 1400, 1500, and 1600 MPa as measured according to ASTM D790 on 3 mm compression molded samples, where any lower limit can be used in combination with any upper limit.

Compositions according to one or more embodiments may have a tensile impact strength (23° C., compression molded) ranging from a lower limit selected from one of 50, 75, and 100 kJ/m2, to an upper limit selected from one of 200, 225, and 250 kJ/m2 according to ISO 8256, where any lower limit can be used in combination with any upper limit.

In another aspect, a method of increasing die swell in a blow molding process is provided. According to one or more embodiments, ethylene and optionally one or more alpha-olefin comonomers may be polymerized by any method suitable to obtain the desired properties. The ethylene may be polymerized, using a ZN catalyst, to obtain at least a lower molecular weight fraction and a higher molecular weight fraction as an in-reactor blend to produce the multimodal HDPE. A low-density polyethylene is blended with the multimodal HDPE to form the composition. In one or more embodiments, the low-density polyethylene may be produced in an autoclave or tubular reactor.

Polymer compositions in accordance with the present disclosure may be prepared by a number of possible polymer blending and formulation techniques, which will be discussed in the following sections.

### Extrusion

In one or more embodiments, polymer compositions in accordance with the present disclosure may be prepared using continuous or discontinuous extrusion. Methods may use single-, twin-or multi-screw extruders, which may be used at temperatures ranging from 100° C. to 270° C. in some embodiments, and from 140° C. to 230° C. in some embodiments. In some embodiments, raw materials are added to an extruder, simultaneously or sequentially, into the main or secondary feeder in the form of powder, granules, flakes or dispersion in liquids as solutions, emulsions and suspensions of one or more components.

The components can be pre-dispersed in prior processes using intensive mixers, for example. Inside an extrusion equipment, the components are heated by heat exchange and/or mechanical friction, the phases are melted and the dispersion occurs by the deformation of the polymer.

In one or more embodiments, methods of preparing polymer compositions may involve a single extrusion or multiple extrusions following the sequences of the blend preparation stages.

Embodiments of the present disclosure further encompass blow molded articles that have at least one layer formed from the aforementioned polymer composition. One or more embodiments include a monolayer blow molded article, while one or more other embodiments include a multilayer blow molded article. In multilayer blow molded articles, at least one layer is formed from the polymer composition of the present disclosure.

Polymer compositions prepared by extrusion may be in the form of granules that are applicable to different molding processes, including processes selected from extrusion blow-molding, injection blow molding, stretch blow molding (SBM), ISBM (Injection Stretch Blow-Molding), foam blow molding and the like, to produce manufactured articles.

The hollow molded article related to the present disclosure may be prepared by a hollow molding (blow molding) method, which may include, for example, an extrusion blow molding method, a two-stage blow molding method and an injection molding method. Blow molding may be accomplished, for example, by extruding molten resin into a mold cavity as a parison or a hollow tube while simultaneously forcing air into the parison so that the parison expands, taking on the shape of the mold. The molten resin cools within the mold until it solidifies to produce the desired molded product. In one more embodiment, the blow molded product may be further subjected to a surface treatment, such as fluorination treatment or the like.

In injection blow molding, a hot preform or parison is injected into a mold, and a blowing nozzle may be inserted into the parison, through which an amount of pressurized air may be blown into the parison, forcing the parison to take the shape of the mold. Once cooled and solidified, the article may be released and finished to remove excess material. Conversely, in extrusion blow molding, the parison may be extruded downward and captured between two halves of a mold that is closed when the parison reaches proper length.

The ISBM process of one or more embodiments may comprise at least an injection molding step and a stretch-blowing step. In the injection molding step a polymer composition is injection molded to provide a preform. In the stretch-blowing step the preform is heated, stretched, and expanded through the application of pressurized gas to provide an article. The two steps may, in some embodiments, be performed on the same machine in a one-stage process. In other embodiments, the two steps may be performed separately in multiple stages.

In foam blow molding, the polymer composition may be co-extruded, depending on the final selection of the composition of each of the layers, to form a parison, wherein the composition of the present disclosure is used in the innermost layer. The extruder forming the middle layer of the multi-layer extrudate may provide for the injection of a physical blowing agent into the extruder, or when a chemical blowing agent is used, the chemical blowing agent may be mixed with the polymer being fed into the extruder. In forming a three-layer article of, three extruders may be used, and a blowing agent is only fed into to the extruder forming the middle layer which will become the foamed layer. Gas, either injected into the extruder or formed through thermal decomposition of a chemical blowing agent in the melting zone of the extruder. The gas (irrespective of the source of the gas) in the polymer forms into bubbles that distribute through the molten polymer. Upon eventual solidification of the molten polymer, the gas bubble result in a cell structure or foamed material.

The parison extruded from the machine head may be captured by a water cooled mold, and a blowing nozzle may be inserted into the parison, through which an amount of pressurized air may be blown into the parison, forcing the parison to take the shape of the mold. Once cooled and solidified, the article may be released and finished to remove excess material.

While the above describes several ways in which blow molding may be achieved, it is also understood that there is no limitation on the particular manner in which the blow molding may occur.

In one or more embodiments, the disclosure relates to blow molded articles. These molded articles include articles (multilayer structures or the like) that contain a part consisting of the resin composition having the described properties and a part consisting of other resins.

The articles of the present disclosure may be for applications such as fuel tanks, cans for industrial chemicals (particularly agrochemicals), bottle containers such as bleacher containers, detergent containers, softener containers, containers for surfactants, cosmetics, detergents, fabric softeners, shampoos, conditioners, hair treatments and the like.

In particular embodiments, the blow molded articles of the present disclosure may be large part blow moldings, encompassing container sizes ranging from at least from 5 gallons (18.9 liters) up to 330 gallons (1250 liters), including at least 5 gallons (18.9 liters) to 55 gallons (208.2 liters); at least from 55 gallons (208.2 liters) up to 275 gallons (1040 liters); or at least 275 gallons (1040 liters) up to 330 gallons (1250 liters). For example, such large articles may hold volumes of 5 gallons (20 liters) in the case of Jerrycans, 30 to 55 gallons in the case of drums and 275 gallons (1040 liters) to 330 gallons (1250 liters) in the case of Industrial Bulk Containers (IBC), for example. However, it is also envisioned that the blow molded articles may also include small parts of less than 5 gallons (18.9 liters), including down to 250 milliliters. Depending on the type of the container, it is envisioned that the blow-molded products formed from the polymer compositions may be stackable or non-stackable.

### EXAMPLES

Blends according to the present disclosure were prepared with different bimodal HDPEs and low density polyethylenes. Properties of LDPEs used in the Examples are shown in Table 1. Properties of some of the HDPEs used in the Examples are shown in Table 2.

TABLE 1
Properties of LDPE

| | LD7000A | TX7001 |
|---|---|---|
| I₂ 190° C./2.16 kg (g/10 min) | 0.34 | 0.14 |
| Density (g/cm³) | 0.921 | 0.922 |
| Mw (kg/mol) | 15.7 | 15.9 |
| Mw/Mn | 8.2 | 8.6 |
| Intrinsic Viscosity (η) (dl/g) | 1.24 | 1.50 |

TABLE 2
Properties of the HDPE polymers

| | | RIGEO | RIGEO | RIGEO | | | | |
|---|---|---|---|---|---|---|---|---|
| | | HD1053M | HD1954M | 4950HS | GF4950HS | GF4950 | BS002W | HS5608 |
| HDPE | I₂ | 0.1 | 0.19 | 0.31 | 0.21 | 0.34 | 0.33 | 0.05 |
| | 190° C./2.16 | | | | | | | |
| | kg | | | | | | | |
| | (g/10 min) | | | | | | | |
| | I₂₁ | 10 | 13 | 19 | 20 | 28 | 28 | 8.5 |
| | 190° C./21.6 | | | | | | | |
| | kg | | | | | | | |
| | (g/10 min) | | | | | | | |
| | Density | 0.953 | 0.954 | 0.953 | 0.951 | 0.956 | 0.959 | 0.954 |
| | (g/cm³) | | | | | | | |
| | Mw | 230 | 220 | 190 | 200 | 180 | 180 | — |
| | (kg/mol) | | | | | | | |
| | Mw/Mn | 18 | 18 | 18 | 20 | 18 | 12 | — |

Example 1: A bimodal HDPE commercially available ethylene/1-butene copolymer produced by slurry polymerization process GF4950HS (produced by Braskem S.A.) was blended with a commercially available low density polyethylene grade produced in autoclave high pressure reactor LD7000A (produced by Braskem S.A.), the results of which are shown in Table 3.

TABLE 3
Results for Example 1

| | | 5% | 10 wt % | 15 wt % |
|---|---|---|---|---|
| | Neat | LD7000A | LD7000A | LD7000A |
| GF4950HS (bimodal HDPE) | 100% | 95 wt % | 90 wt % | 85 wt % |
| LD7000A (LDPE) | 0% | 5 wt % | 10 wt % | 15 wt % |
| Die swell (%) | 128 | 149 | 165 | 174 |
| Δ die swell (blend/neat) | — | 16% | 29% | 36% |
| ESCR (Bent strip test 10% Ig) (F₅₀/h) | 150 | 145 | 85 | 80 |
| Tensile impact strength 23° C. (kJ/m²) | 101 | 106 | — | — |
| Flexural modulus sec 1% (MPa) | 1118 | 1036 | 969 | 929 |
| Density (g/cm³) | 0.951 | 0.949 | 0.948 | 0.946 |
| I₂ (g/10 min) | 0.23 | 0.22 | 0.21 | 0.20 |
| I₂₁ (g/10 min) | 22 | 19 | 18 | 15 |
| MI Ratio I₂₁/I₂ | 96 | 86 | 86 | 75 |
| Complex viscosity ratio 0.12/121 | 24.3 | 25.6 | 26.3 | 27.1 |
| Δ complex viscosity | — | 5% | 8% | 12% |
| ratio (blend/neat) | | | | |
| Tanδ @0.12 | 1.76 | 1.71 | 1.76 | 1.68 |
| Δ tan δ (blend/neat) | — | −3% | 0% | −5% |

Example 2: A bimodal HDPE commercially available ethylene/1-butene copolymer produced by slurry polymerization process RIGEO 4950HS (produced by Braskem S.A.) was blended with LD7000A (Autoclave LDPE) the results of which are shown in Table 4.

TABLE 4
Results for Example 2

| | | 5% | 10% | 15% |
|---|---|---|---|---|
| | Neat | LD7000A | LD7000A | LD7000A |
| RIGEO 4950HS | 100% | 95 wt % | 90 wt % | 85 wt % |
| LD7000A | 0% | 5 wt % | 10 wt % | 15 wt % |
| Die swell (%) | 122 | 151 | 178 | 192 |
| Δ die swell (blend/neat) | — | 24% | 46% | 57% |
| ESCR (Bent strip test 10% Ig) (F₅₀/h) | 285 | 245 | 205 | 180 |
| Tensile impact strength 23° C. (kJ/m²) | 109 | 113 | — | — |
| Flexural modulus sec 1% (MPa) | 1180 | 1128 | 1045 | 988 |
| Density (g/cm³) | 0.953 | 0.951 | 0.950 | 0.949 |
| I₂ (g/10 min) | 0.3 | 0.29 | 0.27 | 0.26 |
| I₂₁ (g/10 min) | 8 | 17 | 15 | 15 |
| MI Ratio I₂₁/I₂ | 27 | 59 | 56 | 58 |
| Complex viscosity ratio 0.12/121 | 18.8 | 19.8 | 20.7 | 21.8 |
| Δ complex viscosity | — | 5% | 10% | 16% |
| ratio (blend/neat) | | | | |
| Tanδ @0.12 | 2.55 | 2.43 | 2.34 | 2.27 |
| Δ tan δ (blend/neat) | — | −5% | −8% | −11% |

Example 3: A bimodal HDPE commercially available ethylene/1-butene copolymer produced by slurry polymerization process RIGEO HD1954M (produced by Braskem S.A.) was blended with LD7000A (Autoclave LDPE) the results of which are shown in Table 5.

TABLE 5
Results for Example 3

| | | 5% | 10% |
|---|---|---|---|
| | Neat | LD7000A | LD7000A |
| RIGEO HD1954M | 100% | 95 wt % | 90 wt % |
| LD7000A | 0% | 5 wt % | 10 wt % |
| Die Swell (%) | 94 | 123 | 148 |
| Δ die swell (blend/neat) | — | 31% | 57% |
| ESCR (FNCT 5 MPa/MEG/80° | 1522 | 1190 | 1067 |
| C.) (min) | | | |
| ESCR (Bent strip test 10% Ig) | 728 | 480 | 430 |
| (F₅₀/h) | | | |
| Tensile impact strength 23° | 146 | 141 | 176 |
| C. (kJ/m²) | | | |
| IZOD impact strength 23° C. | NB | 38 (P) | 39 (P) |
| (kg · cm/cm) | | | |
| Flexural modulus sec 1% (MPa) | 1186 | 1098 | 1061 |
| Density (g/cm³) | 0.951 | 0.949 | 0.949 |
| I₂ (g/10 min) | 0.18 | 0.18 | 0.17 |
| I₂₁ (g/10 min) | 14 | 12 | 11 |
| MI Ratio I₂₁/I₂ | 78 | 69 | 66 |
| Complex viscosity ratio 0.12/121 | 24.0 | 25.0 | 26.0 |
| Δ complex viscosity | — | 4% | 8% |
| ratio (blend/neat) | | | |
| Tanδ @0.12 | 2.18 | 2.12 | 2.07 |
| Δ tan δ (blend/neat) | — | −3% | −5% |

Example 4: A bimodal HDPE commercially available ethylene/1-butene copolymer produced by slurry polymerization process RIGEO HD1053M (produced by Braskem S.A.) was blended with LD7000A (Autoclave LDPE) the results of which are shown in Table 6.

TABLE 6
Results for Example 4

| | | 10% |
|---|---|---|
| | Neat | LD7000A |
| RIGEO HD1053M | 100% | 90 wt % |
| LD7000A | 0% | 10 wt % |
| Die swell (%) | 94 | 146 |
| Δ die swell (blend/neat) | — | 55% |
| ESCR (FNCT 5 MPa/MEG/80° | 3839 | 2231 |
| C.) (min) | | |
| ESCR (Bent strip test 10% Ig) | >1000 | >1000 |
| (F₅₀/h) | | |
| Tensile impact strength 23° | 213 | 221 |
| C. (kJ/m²) | | |
| IZOD impact strength 23° C. | NB | NB |
| (kg · cm/cm) | | |
| Flexural modulus sec 1% (MPa) | 1188 | 1032 |
| Density (g/cm³) | 0.951 | 0.948 |
| I₂ (g/10 min) | 0.1 | 0.1 |
| I₂₁ (g/10 min) | 10.5 | 8.2 |
| MI Ratio I₂₁/I₂ | 105 | 82 |
| Complex viscosity ratio 0.12/121 | 36.1 | 38.2 |
| Δ complex viscosity | — | 6% |
| ratio (blend/neat) | | |
| Tanδ @0.12 | 1.54 | 1.46 |
| Δ tan δ (blend/neat) | — | −6% |

Example 5: A bimodal HDPE commercially available ethylene/1-butene copolymer produced by slurry polymerization process RIGEO HD1053M (produced by Braskem S.A.) was blended with a low-density polyethylene produced in a high-pressure tubular polymerization process TX7001 (produced by Braskem S.A.) the results of which are shown in Table 7.

TABLE 7
Results for Example 5

| | | 5% | 10% | 15% |
|---|---|---|---|---|
| | Neat | TX7001 | TX7001 | TX7001 |
| RIGEO HD1053M | 100% | 95 wt % | 90 wt % | 85 wt % |
| TX7001 | 0% | 5 wt % | 10 wt % | 15 wt % |
| Die swell (%) | 98 | 112 | 134 | 155 |
| Δ die swell (blend/neat) | — | 14% | 37% | 58% |
| ESCR (FNCT 5 MPa/MEG/80° | 3255 | 3074 | 2603 | 1759 |
| C.) (min) | | | | |
| ESCR (Bent strip test 10% Ig) | >1000 | >1000 | >1000 | >1000 |
| (F₅₀/h) | | | | |
| Flexural modulus sec 1% (MPa) | 1190 | 1118 | 1028 | 1011 |
| Tensile impact strength 23° | 180 | 167 | 198 | 199 |
| C. (kJ/m²) | | | | |
| IZOD impact strength 23° | NB | NB | NB | NB |
| C. (kg · cm/cm) | | | | |
| Density (g/cm³) | 0.953 | 0.951 | 0.949 | 0.948 |
| I₂₁ (g/10 min) | 9.8 | 7.8 | 7.0 | 6.4 |
| Complex viscosity ratio 0.12/121 | 36.5 | 38.7 | 39.5 | 41.5 |
| Δ complex viscosity | — | 6% | 8% | 14% |
| ratio (blend/neat) | | | | |
| Tanδ @0.12 | 1.54 | 1.44 | 1.40 | 1.36 |
| Δ tan δ (blend/neat) | — | −6% | −9% | −11% |

Example 6: A bimodal HDPE commercially available ethylene/1-butene copolymer produced by slurry polymerization process GF4950 was blended with LD7000A (Autoclave-LDPE) the results of which are shown in Table 8.

TABLE 8
Results for Example 6

| | | 5% | 10% |
|---|---|---|---|
| | Neat | LD7000A | LD7000A |
| GF4950 | 100% | 95 wt % | 90 wt % |
| LD7000A | 0% | 5 wt % | 10 wt % |
| Die Swell (%) | 141 | 160 | 175 |
| Δ die swell (blend/neat) | — | 13% | 24% |
| ESCR (FNCT 4 MPa/MEG/80° | 190 | 154 | 108 |
| C.) (min) | | | |
| ESCR (Bent strip test 10% Ig) | 30 | 26 | 18 |
| (F₅₀/h) | | | |
| Tensile impact strength 23° | 74 | 71 | 84 |
| C. (kJ/m²) | | | |
| Flexural modulus sec 1% (MPa) | 1364 | 1225 | 1211 |
| Density (g/cm³) | 0.957 | 0.955 | 0.953 |
| I₂ (g/10 min) | 0.38 | 0.37 | 0.34 |
| I₂₁ (g/10 min) | 30 | 27 | 25 |
| MI Ratio I₂₁/I₂ | 80 | 74 | 73 |
| Complex viscosity ratio 0.12/121 | 20.1 | 21.1 | 22.5 |
| Δ complex viscosity | — | 5% | 12% |
| ratio (blend/neat) | | | |
| Tanδ @0.12 | 1.94 | 1.89 | 1.87 |
| Δ tan δ (blend/neat) | — | −3% | −4% |

Example 7: A bimodal HDPE commercially available ethylene/1-butene copolymer produced by slurry polymerization process BS002W (produced by Braskem S.A.) was blended with LD7000A (Autoclave LDPE) the results of which are shown in Table 9.

TABLE 9
Results for Example 7

| | | 5% | 10% |
|---|---|---|---|
| | Neat | LD7000A | LD7000A |
| BS002W | 100% | 95 wt % | 90 wt % |
| LD7000A | 0% | 5 wt % | 10 wt % |
| Die Swell (%) | 117 | 147 | 174 |
| Δ die swell (blend/neat) | — | 26% | 49% |
| ESCR (FNCT 4 MPa/MEG/80° | 240 | 207 | 196 |
| C.) (min) | | | |
| ESCR (Bent strip test 10% Ig) | 28 | 27 | 24 |
| (F₅₀/h) | | | |
| Tensile impact strength 23° | 76 | 105 | 94 |
| C. (kJ/m²) | | | |
| IZOD impact strength 23° C. | 46 (P) | NB | 20 (P) |
| (kg · cm/cm) | | | |
| Flexural modulus sec 1% (MPa) | 1448 | 1391 | 1250 |
| Density (g/cm³) | 0.958 | 0.956 | 0.953 |
| I₂ (g/10 min) | 0.35 | 0.31 | 0.31 |
| I₂₁ (g/10 min) | 22 | 19 | 17 |
| MI Ratio I₂₁/I₂ | 63 | 62 | 56 |
| Complex viscosity ratio 0.12/121 | 17.4 | 18.1 | 19.3 |
| Δ complex viscosity | — | 4% | 11% |
| ratio (blend/neat) | | | |
| Tanδ @0.12 | 2.51 | 2.41 | 2.32 |
| Δ tan δ (blend/neat) | — | −4% | −8% |

Example 8: A bimodal HDPE commercially available ethylene/1-butene copolymer produced by slurry polymerization process BS002W (produced by Braskem S.A.) was blended with LD7000A (Autoclave LDPE) the results of which are shown in Table 10.

TABLE 10
Results for Example 8

| | | 1.5% | 2% | 3% | 4% | 4.5% |
|---|---|---|---|---|---|---|
| | Neat | LD7000A | LD7000A | LD7000A | LD7000A | LD7000A |
| BS002W | 100% | 98.5 wt % | 98 wt % | 97 wt % | 96 wt % | 95.5 wt % |
| LD7000A | 0% | 1.5 wt % | 2 wt % | 3 wt % | 4 wt % | 4.5 wt % |
| Die Swell (%) | 107 | 117 | 122 | 130 | 135 | 137 |
| Δ die swell (blend/neat) | — | 9% | 14% | 21% | 26% | 28% |
| ESCR (FNCT | 256 | 221 | 225 | 220 | 241 | 242 |
| 4 MPa/MEG/80° C.) (min) | | | | | | |
| ESCR (Bent strip test 10% Ig) | 39 | 31 | 31 | 30 | 21 | 29 |
| (F₅₀/h) | | | | | | |
| Tensile impact strength 23° C. | 76 | 83 | 79 | 74 | 81 | 79 |
| (kJ/m²) | | | | | | |
| Flexural modulus sec 1% | 1484 | 1454 | 1420 | 1344 | 1359 | 1326 |
| (MPa) | | | | | | |
| Density (g/cm³) | 0.959 | 0.959 | 0.959 | 0.958 | 0.958 | 0.958 |
| I₂ (g/10 min) | 0.31 | 0.27 | 0.28 | 0.29 | 0.28 | 0.28 |
| I₂₁ (g/10 min) | 19 | 19 | 19 | 18 | 17 | 18 |
| MI Ratio I₂₁/I₂ | 61 | 69 | 67 | 62 | 62 | 63 |
| Complex viscosity ratio | 18.8 | 18.8 | 19.1 | 19.1 | 19.2 | 19.3 |
| 0.12/121 | | | | | | |
| Δ complex viscosity ratio | — | 0% | 2% | 1% | 2% | 3% |
| (blend/neat) | | | | | | |
| Tanδ @0.12 | 2.53 | 2.50 | 2.50 | 2.50 | 2.48 | 2.48 |
| Δ tan δ (blend/neat) | — | −1% | −1% | −1% | −2% | −2% |

Example 9: Comparative examples (CE) of blends of bimodal HDPE (GF4950HS) comprising 0.5 wt % and 1 wt % of commercially available LDPE (LD7000A) were produced and assessed for the same properties as shown in the previous examples. It can be seen that there is a minimal quantity of LDPE that is required to achieve the die swell improvement, as can be seen in Table 11. By the results, it can be seen that it would be required to add more than 1 wt % of LDPE to achieve the desired properties.

TABLE 11
Results for Example 9

| | | CE 0.5% | CE 1 wt % | 5 wt % |
|---|---|---|---|---|
| | Neat | LD7000A | LD7000A | LD7000A |
| GF4950HS (bimodal HDPE) | 100% | 99.5 wt % | 99 wt % | 95 wt % |
| LD7000A (LDPE) | 0% | 0.5 wt % | 1 wt % | 5 wt % |
| Die swell (%) | 130 | 126 | 127 | 148 |
| Δ die swell (blend/neat) | — | −3% | −2% | 14% |
| ESCR (FNCT 5 MPa/MEG/80° | 297 | 273 | 258 | 227 |
| C.) (min) | | | | |
| ESCR (Bent strip test 10% Ig) | 170 | 105 | 110 | 85 |
| (F₅₀/h) | | | | |
| Flexural modulus sec 1% (MPa) | 1165 | 1069 | 1074 | 1008 |
| Density (g/cm³) | 0.954 | — | — | 0.950 |
| I₂ (g/10 min) | 0.18 | — | — | 0.20 |
| I₂₁ (g/10 min) | 19 | — | — | 18 |
| MI Ratio I₂₁/I₂ | 105 | — | — | 89 |
| Complex viscosity ratio 0.12/121 | 25.8 | 24.9 | 25.0 | 25.7 |
| Δ complex viscosity | — | −3% | −3% | 0% |
| ratio (blend/neat) | | | | |
| Tanδ @0.12 | 1.71 | 1.78 | 1.77 | 1.75 |
| Δ tan δ (blend/neat) | — | 4% | 4% | 3% |

Example 10: Comparative examples now using a monomodal HDPE (HS5608) commercially available by Braskem S.A. for blow molding application and blended with commercially available low density polyethylene LD7000A, shows that the improvements in die swell are better achieved when using a bimodal polyethylene HDPE, as shown in Table 12.

TABLE 12
Results for Example 10

| | | CE 0.5% | CE 1 wt % | CE 5 wt % |
|---|---|---|---|---|
| | Neat | LD7000A | LD7000A | LD7000A |
| HS5608 (monomodal HDPE) | 100% | 99.5 wt % | 99 wt % | 95 wt % |
| LD7000A (LDPE) | 0% | 0.5 wt % | 1 wt % | 5 wt % |
| Die swell (%) | 155 | 130 | 131 | 142 |
| Δ die swell (blend/neat) | — | −16% | −15% | −8% |
| ESCR (FNCT 5 MPa/MEG/80° | 395 | 398 | 387 | 362 |
| C.) (min) | | | | |
| ESCR (Bent strip test 10% Ig) | 180 | 180 | 180 | 110 |
| (F₅₀/h) | | | | |
| Flexural modulus sec 1% (MPa) | 1232 | 1090 | 1083 | 1048 |
| Complex viscosity ratio 0.12/121 | 51.4 | 51.4 | 51.7 | 52.7 |
| Δ complex viscosity | — | 0% | 1% | 3% |
| ratio (blend/neat) | | | | |
| Tanδ @0.12 | 1.11 | 1.11 | 1.11 | 1.07 |
| Δ tan δ (blend/neat) | — | 0% | 0% | −3% |

Example 11: A comparison of Ziegler-Natta catalyst based bimodal HDPE with 10% LDPE blends with a commercially available chromium catalyst based monomodal HDPE (HS5608 produced by Braskem S.A.) with similar I₂ for large part blow molding was made, the results of which are shown in Table 13.

TABLE 13
Results for Example 11

| | | Blend with | Blend with | Blend with |
|---|---|---|---|---|
| | Monomodal | Tubular | Autoclave | Autoclave |
| | HDPE | LDPE | LDPE | LDPE |
| Grade | HS5608 | 90 wt % | 90 wt % | 90 wt % |
| | | RIGEO | RIGEO | RIGEO |
| | | HD1053M + | HD1053M + | HD1954M + |
| | | 10 wt % | 10 wt % | 10 wt % |
| | | TX7001 | LD7000A | LD7000A |
| Die swell (%) | 160 | 134 | 146 | 148 |
| ESCR (FNCT 5 MPa/MEG/80° | ≥400 | 2603 | 2231 | 1067 |
| C.) (min) | | | | |
| ESCR (Bent strip test 10% Ig) | ≥170 | >1000 | >1000 | 430 |
| (F₅₀/h) | | | | |
| Flexural modulus sec 1% (MPa) | 1200 | 1028 | 1032 | 1061 |
| Tensile impact strength 23° | 120 | 198 | 221 | 176 |
| C. (kJ/m²) | | | | |
| IZOD impact strength 23° | 27 (P) | NB | NB | 39 (P) |
| C. (kg · cm/cm) | | | | |
| Density (g/cm³) | 0.954 | 0.949 | 0.948 | 0.949 |
| I₂₁ (g/10 min) | 8.5 | 7.0 | 8.2 | 11 |
| Complex viscosity ratio 0.12/121 | 54.0 | 39.5 | 38.2 | 26.0 |
| Tanδ @0.12 | 1.05 | 1.40 | 1.46 | 2.07 |

Example 12: A comparison of Ziegler-Natta catalyst based bimodal HDPE+5% LDPE blends with a commercially available chromium catalyst based monomodal HDPE (HS5403 produced by Braskem S.A.) with similar I₂ for small part blow molding, the results of which are shown in Table 14.

TABLE 14
Results for Example 12

| | Monomodal | Blend with | Blend with |
|---|---|---|---|
| | HDPE | Autoclave LDPE | Autoclave LDPE |
| Grade | HS5403 | 95 wt % | 95 wt % |
| | | GF4950 + | BS002W + |
| | | 5 wt % | 5 wt % |
| | | LD7000A | LD7000A |
| Die Swell (%) | 147 | 160 | 147 |
| ESCR (FNCT 4 MPa/MEG/80° | 210 | 154 | 207 |
| C.) (min) | | | |
| ESCR (Bent strip test 10% Ig) | 40 | 26 | 27 |
| (F₅₀/h) | | | |
| Tensile impact strength 23° | 100 | 71 | 105 |
| C. (kJ/m²) | | | |
| IZOD impact strength 23° C. | 10 (P) | — | NB |
| (kg · cm/cm) | | | |
| Flexural modulus sec 1% (Mpa) | 1200 | 1225 | 1391 |
| Density (g/cm³) | 0.954 | 0.955 | 0.956 |
| I₂ (g/10 min) | 0.31 | 0.37 | 0.31 |
| I₂₁ (g/10 min) | 26 | 27 | 19 |
| MI Ratio I₂₁/I₂ | 84 | 74 | 62 |
| Complex viscosity ratio 0.12/121 | 26.2 | 21.1 | 18.1 |
| Tanδ @0.12 | 1.56 | 1.89 | 2.41 |

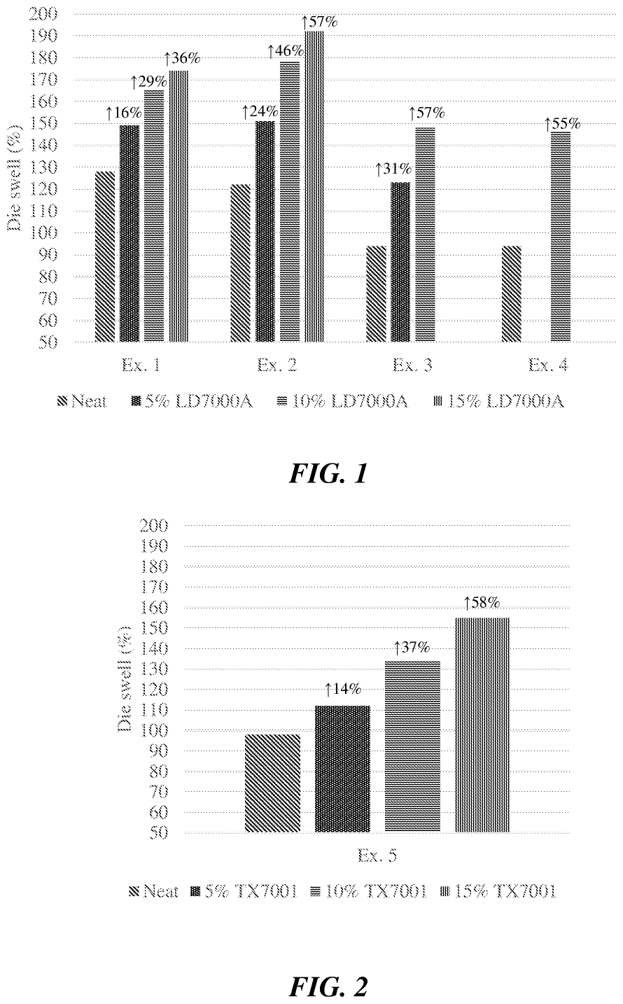

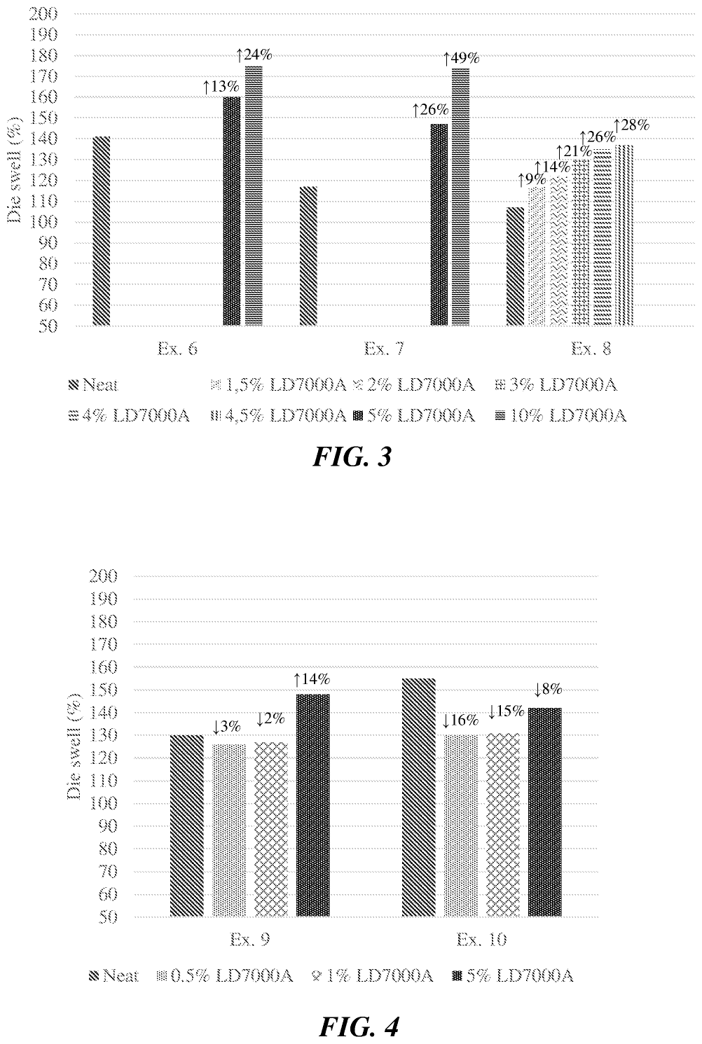

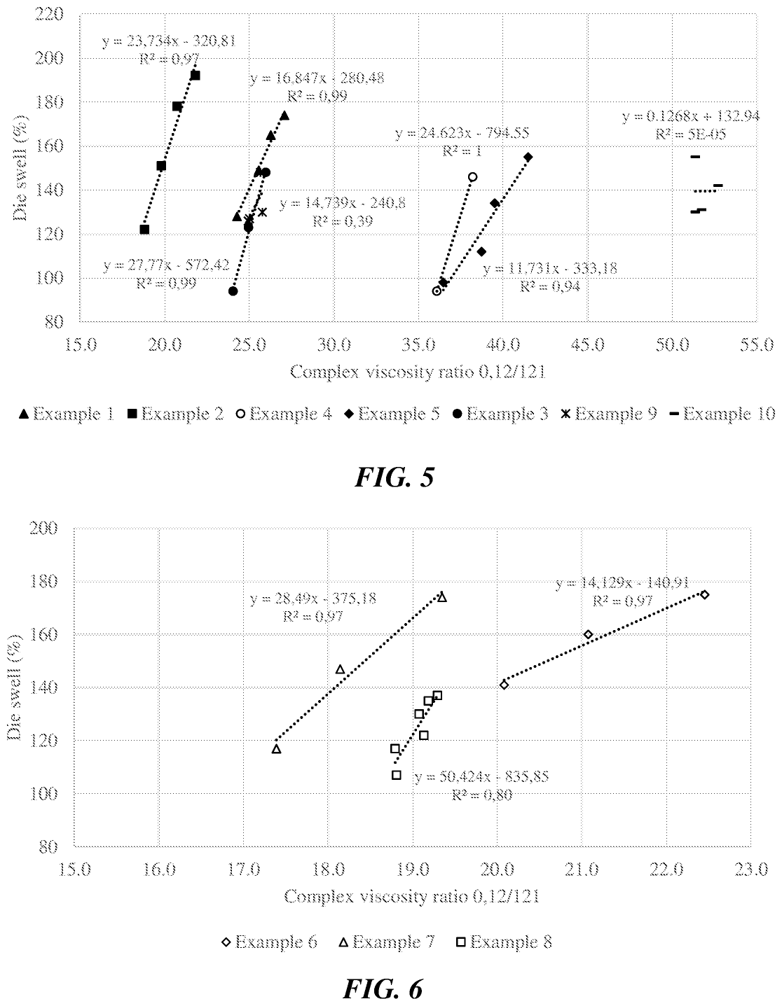

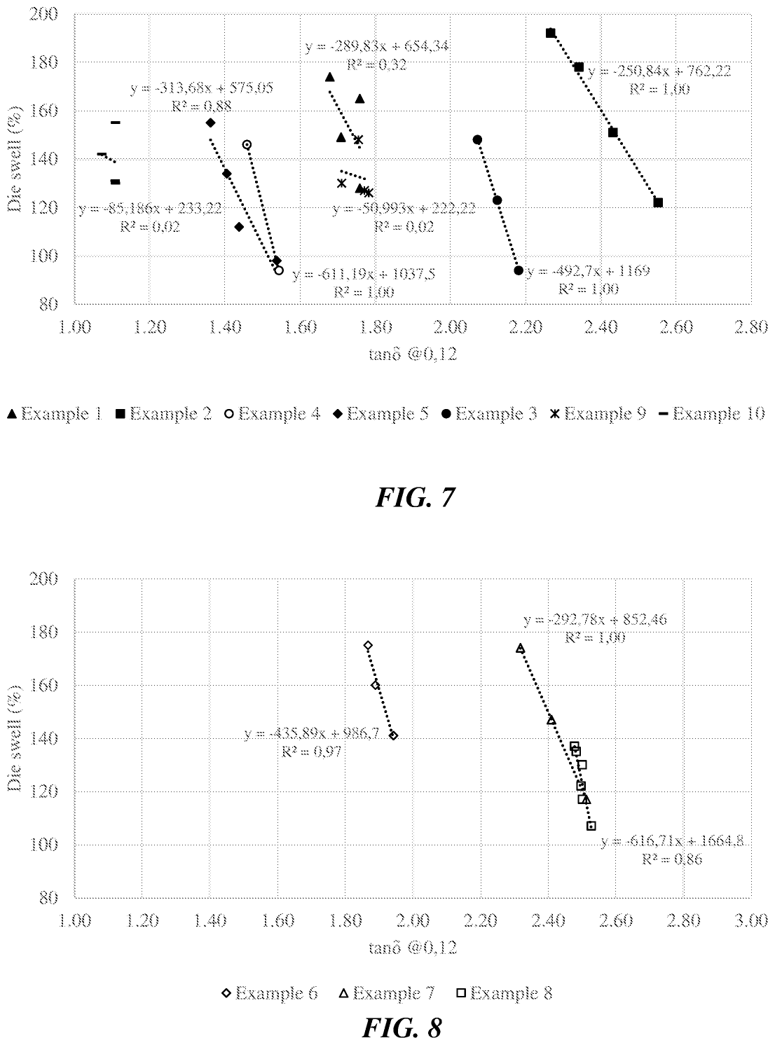

The die swell of multimodal HDPE neat and blended with LD7000A at 5 wt %, 10 wt % and 15 wt % according to Examples 1-4 are shown in FIG. 1. The die swell of RIGEO HD1053M neat and blended with TX7001 at 5 wt %, 10 wt %, and 15 wt % according to Example 5 is shown in FIG. 2. The die swell of multimodal HDPE neat and blended with LD7000A at 1.5 wt %, 2 wt %, 3 wt %, 4 wt %, 4.5 wt %, 5 wt %, and 10 wt according to Examples 6-8 are shown in FIG. 3. FIG. 4 shows the die swell of comparative examples of bimodal and monomodal HDPE neat and blended with an LDPE at 0.5 wt %, 1 wt %, and 5 wt % according to Examples 9-10. FIG. 5 shows the die swell vs. complex viscosity ratio for Examples 1-5 and 9-10. FIG. 6 shows the die swell vs. complex viscosity ratio for Examples 6-8. FIG. 7 shows the die swell vs. tan δ for Examples 1-5 and 9-10. FIG. 8 shows the die swell vs. tan δ for Examples 6-8.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polyethylene composition, comprising:
a multimodal high-density polyethylene comprising:
at least a lower molecular weight fraction, and
at least a higher molecular weight fraction; and
a low-density polyethylene
wherein the low-density polyethylene is present in an amount of greater than 1 to 20% by percent weight of the total composition, and
wherein the multimodal high-density polyethylene is obtained as an in-reactor blend.

2. The composition according to claim 1, wherein the multimodal high-density polyethylene has a density of 0.94 to 0.965 g/cm³.

3. The composition of claim 1, wherein the high density polyethylene is an ethylene copolymer comprising a C3-C20 alpha-olefin comonomer.

4. The composition of claim 3, wherein the alpha-olefin comonomer is 1-butene.

5. The composition according to claim 1, wherein multimodal high-density polyethylene has a molecular weight distribution (Mw/Mn) of 8 to 30.

6. The composition according to claim 1, wherein the lower molecular weight fraction has a density of 0.950 to 0.970 g/cm³.

7. The composition according to claim 1, wherein the higher molecular weight fraction has a density of 0.920 to 0.955 g/cm³.

8. The composition according to claim 1, wherein the lower molecular weight fraction has a melt index measured according to ASTM D1238 at 190° C. and a load of 5.0 kg (I₅) ranging from 30 to 150 g/10 min.

9. The composition according to claim 1, wherein the low-density polyethylene has a density of 0.910 to 0.935 g/cm³.

10. The composition according to claim 1, wherein the low-density polyethylene has a melt index measured according to ASTM D1238 at 190° C. and a load of 2.16 kg (I₂) ranging from 0.01 to 1.0 g/10 min.

11. The composition according to claim 1, wherein the low-density polyethylene is obtained by a high pressure polymerization process.

12. The composition of claim 11, wherein the high pressure polymerization process is conducted in an autoclave reactor.

13. The composition of claim 11, wherein the high pressure polymerization process is conducted in a tubular reactor.

14. The composition according to claim 1, wherein the multimodal high-density polyethylene is present in an amount of 80 to 97 by percent weight of the total composition.

15. The composition according to claim 1, wherein the lower molecular weight fraction is present in an amount of 40 to 70 by percent weight of the multimodal high-density polyethylene.

16. The composition according to claim 1, wherein the higher molecular weight fraction is present in an amount of 30 to 60 by percent weight of the multimodal high-density polyethylene.

17. The composition according to claim 1, wherein the multimodal high density polyethylene is a bimodal high density polyethylene.

18. The composition according to claim 1, wherein the low-density polyethylene has an intrinsic viscosity ranging from 1.0 to 2.0 dl/g as measured according to ASTM D445.

19. The composition according to claim 1, wherein the low-density polyethylene has a weight average molecular weight (Mw) ranging from 10 to 20 kg/mol.

20. The composition according to claim 1, wherein the multimodal high-density polyethylene is polymerized in the presence of a Ziegler-Natta catalyst.

21. The composition according to claim 1, wherein a die swell increase of the polyethylene composition, relative to a die swell of the multimodal high-density polyethylene is between 10 and 70%.

22. The composition according to claim 1, wherein the polyethylene composition has a result of Bent strip test in 10% Igepal CO-630 in water (F₅₀) at 50° C. of at least 10 h measured according to ASTM D1693, condition B.

23. The composition according to claim 1, wherein the polyethylene composition has a complex viscosity ratio (ratio of complex viscosity at a frequency of 0.12 rad/s to the complex viscosity at a frequency of 121 rad/s) of 10 to 50 as measured according to ASTM D440.

24. The composition according to claim 1, wherein an increase in complex viscosity ratio (ratio of complex viscosity at a frequency of 0.12 rad/s to the complex viscosity at a frequency of 121 rad/s), relative to a complex viscosity ratio of the multimodal high-density polyethylene as measured according to ASTM D440, is in the range of 0.1% to 30%.

25. The composition according to claim 1, wherein the polyethylene composition has a tan δ measured at a frequency of 0.12 rad/s of 0.7 to 3.5 as measured according to ASTM D440.

26. The composition according to claim 1, wherein a reduction in tan δ measured at a frequency of 0.12 rad/s of the polyethylene composition, relative to a tan δ measured at a frequency of 0.12 rad/s of the multimodal high-density polyethylene as measured according to ASTM D440, is in the range of 0.1% to 20%.

27. The composition according to claim 1, wherein the polyethylene composition has a melt index (I₂₁) measured according to ASTM D1238 at 190° C. and a load of 21.6 kg of 4 to 40 g/10 min.

28. The composition according to claim 1, wherein the polyethylene composition has a linear relationship between die swell (DS) and complex viscosity ratio (ratio of complex viscosity at a frequency of 0.12 rad/s to the complex viscosity at a frequency of 121 rad/s) (CVR) according to the following equation: DS=(CVR*a1)−b1, where 5<a1<100 and 100<b1<2000, wherein the linear relationship is obtained by a linear regression of a CVR versus DS absolute values measured for at least three polyethylene compositions comprising the bimodal HDPE and 0 wt %, 5 wt % and 10 wt % of the low-density polyethylene.

29. The composition according to claim 1, wherein the polyethylene composition shows linear relationship between die swell (DS) and tan δ measured at a frequency of 0.12 rad/s (tan δ) according to the following equation: DS=-(tan δ*a2)+b2, where 200<a2<2000 and 300<b2<3300, wherein the linear relationship is obtained by a linear regression of a tan δ versus DS absolute values measured for at least three polyethylene compositions comprising the bimodal HDPE and 0 wt %, 5 wt % and 10 wt % of the low-density polyethylene.

30. A method of increasing die swell in a blow molding process, the method comprising:
polymerizing ethylene and optionally one or more alpha-olefin comonomers to obtain a multimodal HDPE comprising at least a lower molecular weight fraction and a higher molecular weight fraction;
blending a low-density polyethylene with the multimodal HDPE to form the composition of claim 1.

31. The method of claim 30, wherein the polymerizing is conducted in two or more serially connected polymerization reactors with a Ziegler-Natta catalyst.

32. The method of claim 30, wherein polymerizing is conducted in a slurry polymerization process.

33. A blow-molded article comprising the composition of claim 1.

34. A method of blow molding a polyethylene composition, the method comprising:
injecting a composition according to claim 1 into a mold, and
molding the composition by blow-molding.
